(19) United States
(12) Patent Application Publication
(10) Pub. No.: US 2026/0309298 A1
(43) Pub. Date: Oct. 8, 2026

(54) VEHICLE LAMP AND LIGHT GUIDE BODY

(71) Applicant: Stanley Electric Co., Ltd., Tokyo (JP)

(72) Inventor: Takaaki ONOTSUKA, Tokyo (JP)

(21) Appl. No.: 19/482,621

(22) PCT Filed: May 10, 2024
(86) PCT No.: PCT/JP2024/017332

§ 371 Date: Nov. 7, 2025

(30) Foreign Application Priority Data
May 11, 2023 (JP) 2023-078376

(51) Int. Cl. F21S 43/241; F21S 43/235; F21S 43/249; F21W 103/10; F21W 103/20; F21W 103/55; F21Y 115/10

(52) U.S. Cl. CPC F21S 43/241; F21S 43/249; F21S 43/252; F21W 2103/10; F21W 2103/20; F21W 2103/55; F21Y 2115/10

(57) ABSTRACT

The vehicle lamp includes: a light source; an inner lens configured to include a wide region and a narrow region; and a light guide body configured to include at least one bar-shaped light guide unit that guides light emitted by the light source. The bar-shaped light guide unit includes a first bar-shaped light guide unit and a second bar-shaped light guide unit. A cross-sectional shape of the first bar-shaped light guide unit and a cross-sectional shape of the second bar-shaped light guide unit are set to different shapes from each other such that an angle range of light which is outputted from a light output surface of the first bar-shaped light guide unit is larger than an angle range of light which is outputted from a light output surface of the second bar-shaped light guide unit.

This application is a U.S. National Stage Application under 35 U.S. C § 371 of International Patent Application No. PCT/JP2024/017332 filed May 10, 2024, which claims the benefit of priority under 35 U.S.C. § 119 to Japanese Patent Application No. 2023-078376 filed May 11, 2023, the disclosures of all of which are hereby incorporated by reference in their entireties.

### TECHNICAL FIELD

The present disclosure relates to a vehicle lamp and a light guide body.

### BACKGROUND ART

A vehicle lamp using a bar-shaped light guide unit having a ginkgo leaf-shaped cross section is known (see, for example, Patent Literature 1).

### CITATION LIST

### Patent Literature

### [Patent Literature 1]

Japanese Unexamined Patent Application Publication No. 2014-116142

### SUMMARY OF INVENTION

### Technical Problem

However, the vehicle lamp described in Patent Literature 1 has a problem in that a first region having a width corresponding to an angle range of light which is outputted from a light output surface of a bar-shaped light guide unit having a ginkgo leaf-shaped cross section transmits light which is outputted from the light output surface of the bar-shaped light guide unit, and thus the first region can emit light uniformly (or substantially uniformly), whereas, in a second region having a width larger than the width of the first region, a region that is present out of the angle range of light which is outputted from the light output surface of the bar-shaped light guide unit does not transmit light which is outputted from the light output surface of the bar-shaped light guide unit, and thus the second region cannot emit light uniformly (or substantially uniformly) (a relatively dark portion is generated in a part of the second region).

The present disclosure is made to solve such a problem, and an object of the present disclosure is to provide a vehicle lamp and a light guide body enabling a wide region and a narrow region to emit light uniformly (or substantially uniformly) (a dark portion that is relatively dark is not generated in a part of the wide region).

### Solution to Problem

A vehicle lamp according to the present disclosure includes: a light source; an inner lens configured to include a wide region and a narrow region; and a light guide body configured to include at least one bar-shaped light guide unit that guides light emitted by the light source. The bar-shaped light guide unit includes a first bar-shaped light guide unit extending in a first direction and a second bar-shaped light guide unit extending in a second direction. A cross-sectional shape of the first bar-shaped light guide unit and a cross-sectional shape of the second bar-shaped light guide unit are set to different shapes from each other such that an angle range of light which is guided in the first bar-shaped light guide unit and is outputted from a light output surface of the first bar-shaped light guide unit is larger than an angle range of light which is guided in the second bar-shaped light guide unit and is outputted from a light output surface of the second bar-shaped light guide unit. The first bar-shaped light guide unit is arranged behind the wide region such that light which is outputted from the light output surface of the first bar-shaped light guide unit is transmitted through the corresponding wide region. The second bar-shaped light guide unit is arranged behind the narrow region such that light which is outputted from the light output surface of the second bar-shaped light guide unit is transmitted through the corresponding narrow region.

Such a configuration enables the wide region and the narrow region to uniformly (or substantially uniformly) emit light (without producing a dark portion that is relatively dark at a part of the wide region).

This is because, firstly, the cross-sectional shape of the first bar-shaped light guide unit and the cross-sectional shape of the second bar-shaped light guide unit are set to different shapes from each other such that the angle range of light which is guided in the first bar-shaped light guide unit and is outputted from the light output surface of the first bar-shaped light guide unit is larger than the angle range of light which is guided in the second bar-shaped light guide unit and is outputted from the light output surface of the second bar-shaped light guide unit, and secondly, the first bar-shaped light guide unit is arranged behind the wide region such that light which is outputted from the light output surface of the first bar-shaped light guide unit is transmitted through the corresponding wide region, and the second bar-shaped light guide unit is arranged behind the narrow region such that light which is outputted from the light output surface of the second bar-shaped light guide unit is transmitted through the corresponding narrow region.

In addition, in the vehicle lamp, the cross-sectional shape of the first bar-shaped light guide unit may be a fan shape, and the cross-sectional shape of the second bar-shaped light guide unit may be a ginkgo leaf shape.

In addition, in the vehicle lamp, the second direction may be a direction intersecting the first direction, the light guide body may include a third bar-shaped light guide unit having a curved shape which connects the first bar-shaped light guide unit and the second bar-shaped light guide unit, and a cross-sectional shape of the third bar-shaped light guide unit may be a shape which gradually changes from the fan shape to the ginkgo leaf shape as approaching the second bar-shaped light guide unit from the first bar-shaped light guide unit.

In addition, in the vehicle lamp, a diameter of the first bar-shaped light guide unit may be substantially equal to a diameter of the second bar-shaped light guide unit.

In addition, in the vehicle lamp, curvature of the light output surface of the first bar-shaped light guide unit and curvature of the light output surface of the second bar-shaped light guide unit may be different from each other.

In addition, in the vehicle lamp, the light guide body may include a plurality of the bar-shaped light guide units arranged in parallel with each other.

In addition, in the vehicle lamp, the plurality of bar-shaped light guide units may join each other on respective proximal end sides to form one joining portion having no boundary therebetween, and the joining portion may have, at a distal end thereof, a light incident surface on which light emitted from the light source is incident.

A light guide body according to the present disclosure includes at least one bar-shaped light guide unit that guides light emitted by a light source. The bar-shaped light guide unit includes a first bar-shaped light guide unit extending in a first direction and a second bar-shaped light guide unit extending in a second direction. A cross-sectional shape of the first bar-shaped light guide unit and a cross-sectional shape of the second bar-shaped light guide unit are set to different shapes from each other such that an angle range of light that is guided in the first bar-shaped light guide unit and is outputted from a light output surface of the first bar-shaped light guide unit is larger than an angle range of light that is guided in the second bar-shaped light guide unit and is outputted from a light output surface of the second bar-shaped light guide unit.

Such a configuration enables the wide region and the narrow region to uniformly (or substantially uniformly) emit light (without producing a dark portion that is relatively dark at a part of the wide region).

This is because the cross-sectional shape of the first bar-shaped light guide unit and the cross-sectional shape of the second bar-shaped light guide unit are set to different shapes from each other such that the angle range of light which is guided in the first bar-shaped light guide unit and is outputted from the light output surface of the first bar-shaped light guide unit is larger than the angle range of light which is guided in the second bar-shaped light guide unit and is outputted from the light output surface of the second bar-shaped light guide unit.

### Advantageous Effects of Invention

According to the present disclosure, it is possible to provide a vehicle lamp and a light guide body that enable a wide region and a narrow region to uniformly (or substantially uniformly) emit light (without producing a dark portion that is relatively dark at a part of the wide region).

### BRIEF DESCRIPTION OF DRAWINGS

FIG. 1A is a front view of a vehicle lamp 10;

FIG. 1B is a view with a light-emitting region drawn in FIG. 1A;

FIG. 2 is a perspective view of a light guide body 20, a bracket 60, and an inner lens 70 picked out from FIG. 1A;

FIG. 3 is a cross-sectional view taken along line III-III in FIG. 1A;

FIG. 4 is a cross-sectional view taken along line IV-IV in FIG. 1A;

FIG. 5 is a cross-sectional view taken along line V-V in FIG. 1A;

FIG. 6 is a view of a substrate 40 in a direction of an arrow Arl in FIG. 5;

FIG. 7 is an enlarged perspective view of the vicinity of a light incident surface 22 of a bar-shaped light guide unit 21 in a direction of an arrow Ar2 in FIG. 2;

FIG. 8A is a view illustrating an angle range θ1 of light which is outputted from a light output surface 212a of a (one) second bar-shaped light guide unit 212 of a comparative example;

FIG. 8B is a view illustrating a range of light which is outputted from the light output surfaces 212a of the (three) second bar-shaped light guide units 212 of the comparative example;

FIG. 8C is a view illustrating an angle range θ2 of light which is outputted from the light output surface of a (one) first bar-shaped light guide unit 211 of an embodiment;

FIG. 8D is a view illustrating a range of light which is outputted from the light output surfaces of the (three) first bar-shaped light guide units 211 of the embodiment;

FIG. 9 illustrates a first modified example of the bar-shaped light guide unit 21 and the inner lens 70;

FIG. 10 illustrates a second modified example of the bar-shaped light guide unit 21 and the inner lens 70;

FIG. 11 illustrates a third modified example of the bar-shaped light guide unit 21 and the inner lens 70; and

FIG. 12 is a view illustrating a cross-sectional shape of the bar-shaped light guide unit 21.

### DESCRIPTION OF EMBODIMENTS

Hereinafter, a vehicle lamp 10 according to an embodiment of the present disclosure will be described with reference to the accompanying drawings. In the drawings, corresponding components are denoted by the same reference numerals, and repeated descriptions are omitted.

The vehicle lamp 10 of the embodiment is a vehicle lamp that functions as a turn signal lamp, a DRL lamp, or a position lamp (a signature lamp or a vehicle signal lamp), and the vehicle lamps 10 are mounted respectively on both left and right sides of a front end of a vehicle (not illustrated) such as an automobile. Since the vehicle lamps 10 mounted respectively on both the left and right sides have respective symmetrical configurations, the vehicle lamp 10 mounted on the left side (the left side when viewed toward the front of the vehicle) of the front end of the vehicle will be described below as a representative.

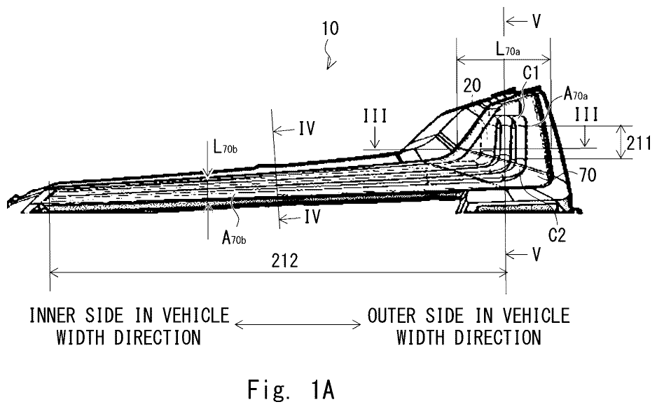

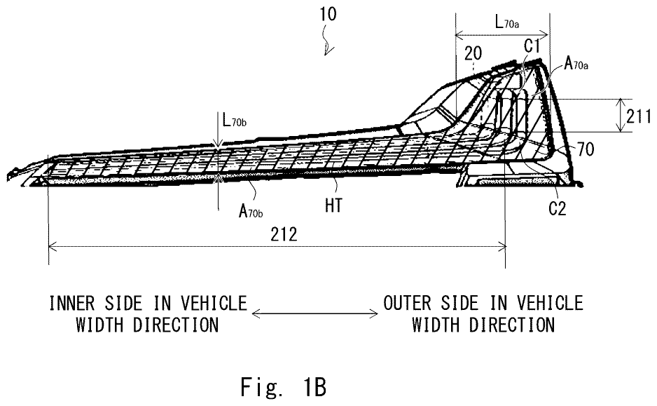

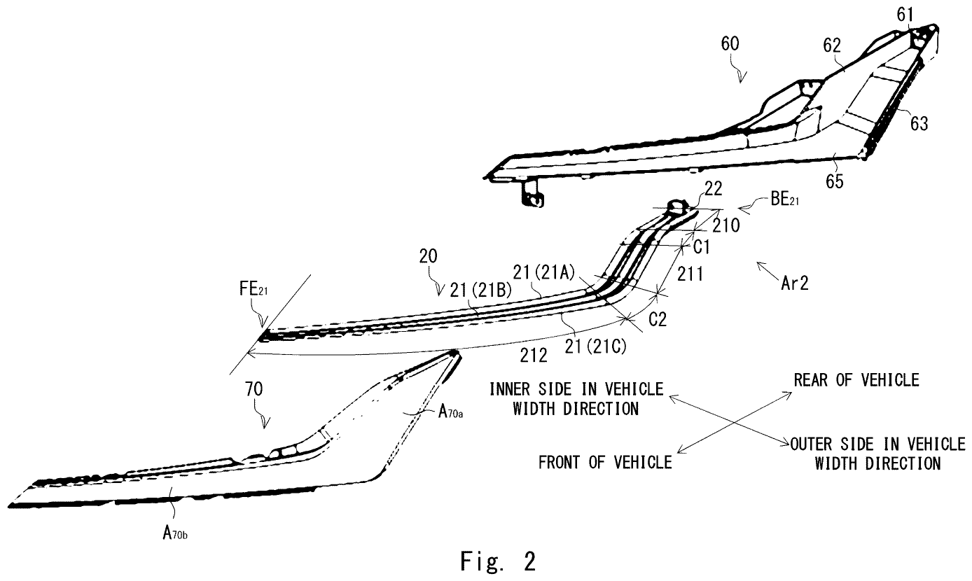

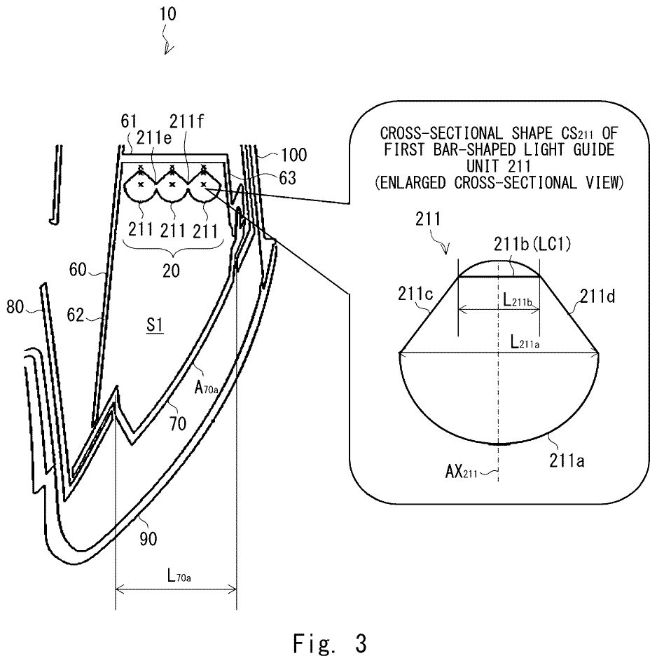

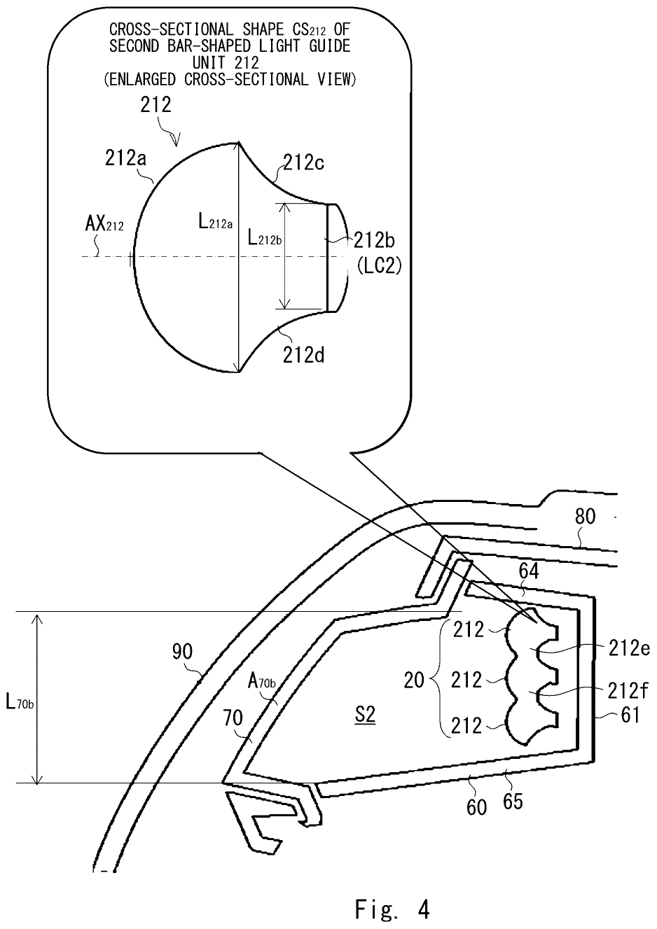

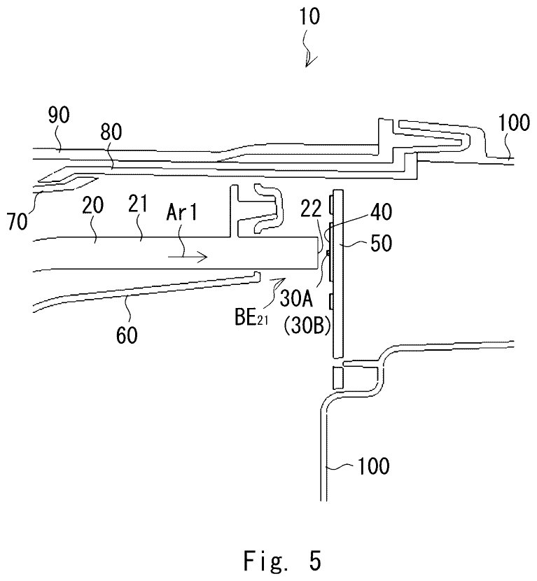

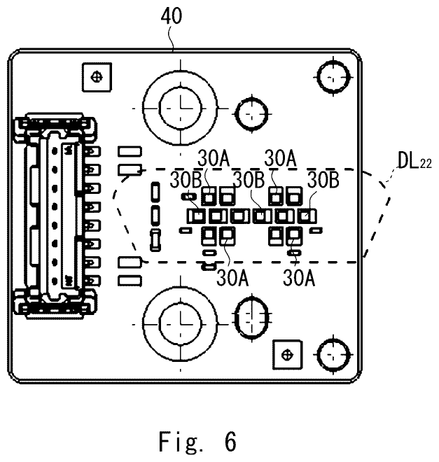

FIG. 1A is a front view of the vehicle lamp 10, and FIG. 1B is a view with a light-emitting region drawn in FIG. 1A. FIG. 2 is a perspective view of a light guide body 20, a bracket 60, and an inner lens 70 picked out from FIG. 1A. FIG. 3 is a cross-sectional view taken along line III-III in FIG. 1A, FIG. 4 is a cross-sectional view taken along line IV-IV in FIG. 1A, and FIG. 5 is a cross-sectional view taken along line V-V in FIG. 1A. FIG. 6 is a view of a substrate 40 in a direction of an arrow Arl in FIG. 5.

As illustrated in FIGS. 1A to 6, the vehicle lamp 10 includes the light guide body 20, a substrate 40 on which a first light source 30A and a second light source 30B are mounted, a heat sink 50 to which the substrate 40 is attached, a bracket 60 to which the light guide body 20 is attached, the inner lens 70, an extension 80 which is a decorative member, an outer lens 90, and a housing 100. The light guide body 20, the substrate 40, the heat sink 50, the bracket 60, the inner lens 70, and the extension 80 are arranged in a lamp chamber formed of the outer lens 90 and the housing 100 and are attached to the housing 100 or the like.

The inner lens 70 is made of a transparent resin such as an acrylic resin or a polycarbonate resin and is formed in an L shape in front view as illustrated in FIG. 1A. Specifically, the inner lens 70 includes a wide region A₇₀ₐ and a narrow region A_{70b}. The wide region A₇₀ₐ is arranged on an outer side in a vehicle width direction and extends in a vertical direction. A width L₇₀ₐ of the wide region A₇₀ₐ is, for example, 60 mm. Meanwhile, the narrow region A_{70b} extends toward an inner side in the vehicle width direction from a lower end of the wide region A₇₀ₐ. A width L_{70b} of the narrow region A_{70b} is, for example, 30 mm.

As will be described below, light guided by the light guide body 20 arranged behind the inner lens 70 is transmitted through the inner lens 70 (the wide region A₇₀ₐand the narrow region A_{70b}). This makes the inner lens 70 (the wide region A₇₀ₐand the narrow region A_{70b}) emit light. In FIG. 1B, a hatched region HT represents a light-emitting region.

As illustrated in FIGS. 3 and 4, the light guide body 20 is arranged behind the inner lens 70 in a state of being attached to the bracket 60. The bracket 60 is made of, for example, a white resin functioning as a reflective surface and includes a bracket main body 61, left and right wall portions 62 and 63 (see FIG. 3) extending from both left and right sides of the bracket main body 61 toward the inner lens 70, and upper and lower wall portions 64 and 65 (see FIG. 4) extending from both upper and lower sides of the bracket main body 61 toward the inner lens 70.

The light guide body 20 is made of a transparent resin such as an acrylic resin or a polycarbonate resin and includes three bar-shaped light guide units 21A to 21C arranged parallel to each other as illustrated in FIG. 2. The bar-shaped light guide unit is also called a light guide bar. Hereinafter, the bar-shaped light guide units 21A to 21C will be simply described as a bar-shaped light guide unit 21 unless otherwise distinguished.

The bar-shaped light guide unit 21 guides light emitted from the first light source 30A and the second light source 30B. As illustrated in FIG. 2, the bar-shaped light guide unit 21 is a long light guide bar that guides incident light from a light incident surface 22 which is an end surface on a proximal end BE₂₁ side toward a distal end FE₂₁ side and is formed in a three-dimensionally curved shape corresponding to the shape (here, the L-shape) of the inner lens 70. Specifically, the bar-shaped light guide unit 21 includes a joining portion 210 extending from the proximal end BE₂₁ side toward the front of the vehicle, a first bar-shaped light guide unit 211 extending obliquely downward toward the front (an example of a first direction of the present disclosure) via a first curved portion C1 from the joining portion 210, and a second bar-shaped light guide unit 212 extending inward in the vehicle width direction (an example of a second direction of the present disclosure) via a second curved portion C2 from the first bar-shaped light guide unit 211.

As illustrated in FIG. 3, the first bar-shaped light guide unit 211 is arranged behind the wide region A₇₀ₐ of the inner lens 70 such that light which is outputted from a light output surface 211a of this first bar-shaped light guide unit 211 is transmitted through the wide region A₇₀ₐ. Specifically, the first bar-shaped light guide unit 211 is arranged on a rear side of the vehicle in a space S1 surrounded by the bracket main body 61, the left and right wall portions 62 and 63 of the bracket 60, and the inner lens 70.

Meanwhile, as illustrated in FIG. 4, the second bar-shaped light guide unit 212 is arranged behind the narrow region A_{70b} of the inner lens 70 such that light which is outputted from a light output surface 212a of the second bar-shaped light guide unit 212 is transmitted through the narrow region A_{70b}. Specifically, the second bar-shaped light guide unit 212 is arranged on the rear side of the vehicle in a space S2 surrounded by the bracket main body 61, the upper and lower wall portions 64 and 65 of the bracket 60, and the inner lens 70.

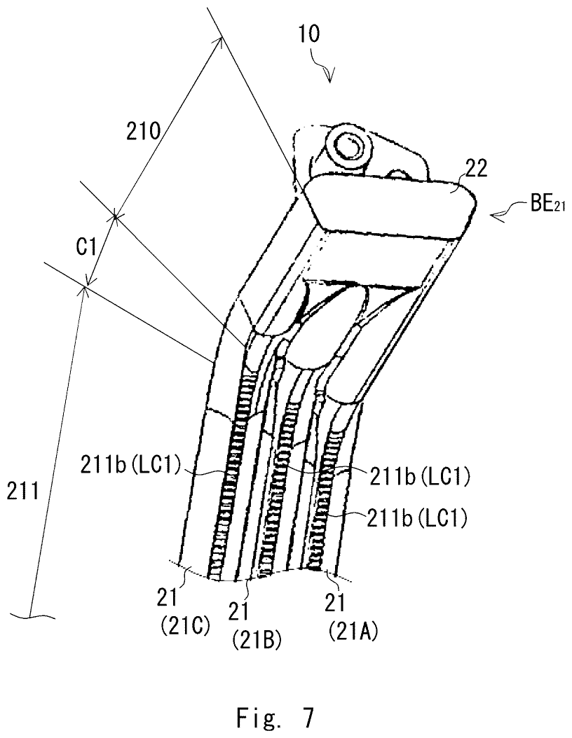

FIG. 7 is an enlarged perspective view of the vicinity of a light incident surface 22 of the bar-shaped light guide unit 21 in a direction of an arrow Ar2 in FIG. 2.

As illustrated in FIG. 7, the proximal end BE₂₁ of the bar-shaped light guide unit 21 includes a common light incident surface 22. The light incident surface 22 has, for example, a flat surface shape orthogonal to a longitudinal direction of the bar-shaped light guide unit 21 (a direction in which the bar-shaped light guide unit 21 extends) (see FIG. 5). Note that the shape of the light incident surface 22 is not limited to the flat surface shape and may be a curved surface shape or a cap shape protruding toward the first light source 30A and the second light source 30B.

Portions of the bar-shaped light guide units 21A to 21C between the light incident surface 22 and the first curved portion C1 join each other and form one joining portion 210 (entrance zone) having no boundary therebetween (see FIG. 7). The light incident surface 22 is provided at a distal end of the joining portion 210. The joining portion 210 is provided, thereby enabling light (light emitted from the first light source 30A and the second light source 30B) incident from the light incident surface 22 to be uniformly incident on the bar-shaped light guide units 21A to 21C. The light guide body 20 is attached to the bracket 60 in a state in which the light incident surface 22 faces the first light source 30A and the second light source 30B (see FIG. 5).

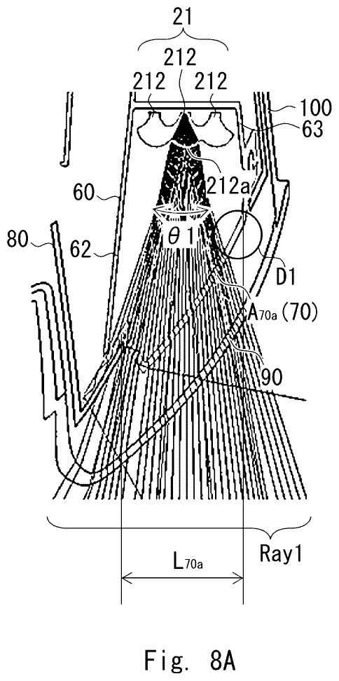

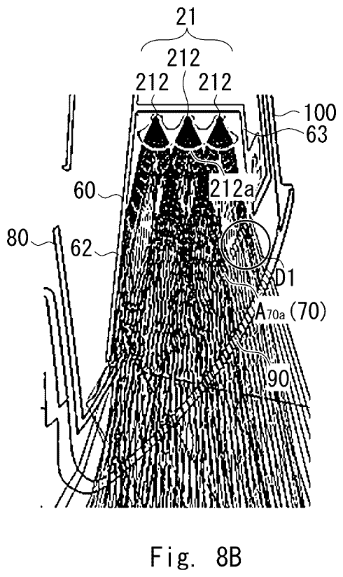

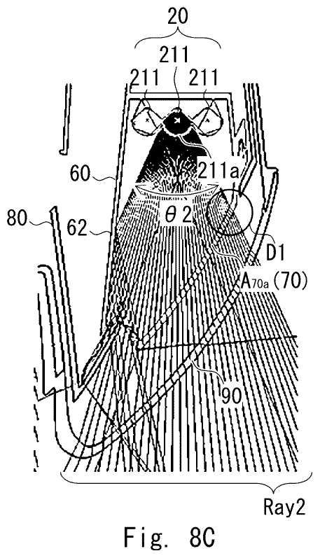

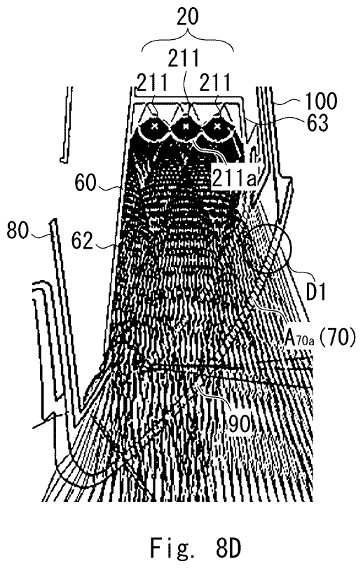

A cross-sectional shape of the first bar-shaped light guide unit 211 and a cross-sectional shape of the second bar-shaped light guide unit 212 are set to different shapes from each other such that an angle range θ2 (see FIG. 8C) of light Ray2 which is guided in the first bar-shaped light guide unit 211 and is outputted from the light output surface 211a of the first bar-shaped light guide unit 211 is larger than an angle range θ1 (see FIG. 8A) of light Ray1 which is guided in the second bar-shaped light guide unit 212 and is outputted from the light output surface 212a of the second bar-shaped light guide unit 212. This point will be specifically described below.

First, the cross-sectional shape of the first bar-shaped light guide unit 211 will be described.

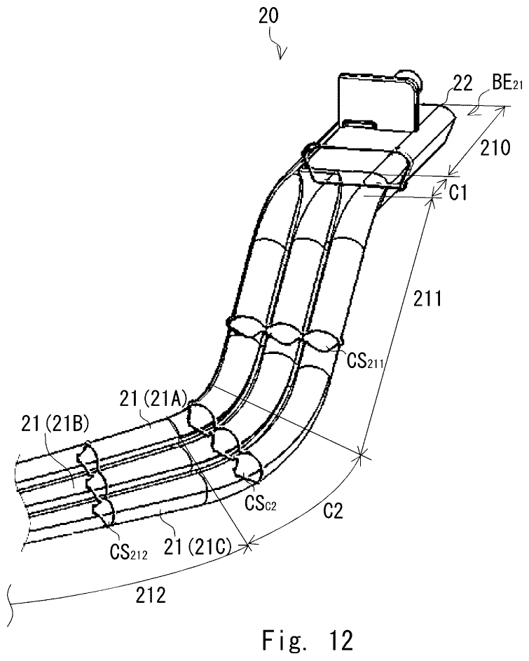

FIG. 12 is a view illustrating the cross-sectional shape of the bar-shaped light guide unit 21.

As illustrated in FIGS. 3 and 12, a cross-sectional shape CS₂₁₁ of the first bar-shaped light guide unit 211 is a fan shape that is line-symmetric with respect to an optical axis AX₂₁₁ of the first bar-shaped light guide unit 211. Specifically, the first bar-shaped light guide unit 211 includes the light output surface 211a, a first reflective surface 211b on an opposite side thereof, and a pair of second reflective surfaces 211c and 211d on both sides thereof. Note that the cross-sectional shape CS₂₁₁ of the first bar-shaped light guide unit 211 may not be a perfect fan shape and may be a rough fan shape.

The light output surface 211a is arranged on a front surface side (the front side of the vehicle) in a state in which the inner lens 70 faces the light output surface. Meanwhile, the first reflective surface 211b is arranged on a back surface side (the rear side of the vehicle) in a state in which the bracket 60 (the bracket main body 61) faces the first reflective surface.

A cross-sectional shape of the light output surface 211a is an arc shape protruding toward the front surface side (a light irradiation direction. a downward direction in FIG. 3).

Meanwhile, a cross-sectional shape of the first reflective surface 211b is a linear shape intersecting (orthogonal to) the optical axis AX₂₁₁ of the first bar-shaped light guide unit 211. A length L_{211b} of the first reflective surface 211b is shorter than a length L₂₁₁ₐ of the light output surface 211a.

The first reflective surface 211b includes an optical element LC1 (see FIG. 7) configured to cause light which is guided in the first bar-shaped light guide unit 211 and is incident on the first reflective surface 211b to be internally reflected (totally reflected) and outputted from the light output surface 211a. A plurality of optical elements LC1 are provided in a longitudinal direction of the first bar-shaped light guide unit 211. The optical element LC1 is, for example, a lens cut (for example, a V-shaped groove).

In addition, a cross-sectional shape of the second reflective surface 211c is a linear shape and connects one end of the light output surface 211a and one end of the first reflective surface 211b (see FIG. 3). Similarly, a cross-sectional shape of the second reflective surface 211d is a linear shape and connects the other end of the light output surface 211a and the other end of the first reflective surface 211b (see FIG. 3).

As illustrated in FIG. 3, in the embodiment, the three first bar-shaped light guide units 211 are arranged in a state of being adjacent to each other in a crosswise direction (the vehicle width direction). At this time, the first bar-shaped shaped light guide units 211 adjacent to each other are connected to each other via connection portions 211e and 211f. Note that the connection portions 211e and 211f are so-called coupling portions having no optical function.

Next, the cross-sectional shape of the second bar-shaped light guide unit 212 will be described.

As illustrated in FIGS. 4 and 12, a cross-sectional shape CS₂₁₂ of the second bar-shaped light guide unit 212 is a ginkgo leaf shape that is line-symmetric with respect to an optical axis AX₂₁₂ of the second bar-shaped light guide unit 212. Specifically, the second bar-shaped light guide unit 212 includes the light output surface 212a, a first reflective surface 212b on an opposite side thereof, and a pair of second reflective surfaces 212c and 212d on both sides thereof. Note that the cross-sectional shape CS₂₁₂ of the second bar-shaped light guide unit 212 may not be a perfect ginkgo leaf shape and may be a rough ginkgo leaf shape.

The light output surface 212a is arranged on the front surface side (the front side of the vehicle) in a state in which the inner lens 70 faces the light output surface. Meanwhile, the first reflective surface 212b is arranged on the back surface side (the rear side of the vehicle) in a state in which the bracket 60 (the bracket main body 61) faces the first reflective surface.

A cross-sectional shape of the light output surface 212a is an arc shape protruding toward the front surface side (a light irradiation direction. a leftward direction in FIG. 4). A diameter (see a distance L₂₁₂ₐ in FIG. 4) of the light output surface 212a of the second bar-shaped light guide unit 212 is substantially equal to a diameter (see a distance L₂₁₁ₐ in FIG. 3) of the light output surface 211a of the first bar-shaped light guide unit 211. Note that curvature of the light output surface 212a of the second bar-shaped light guide unit 212 and curvature of the light output surface 211a of the first bar-shaped light guide unit 211 are equal to each other, and may be different from each other.

Meanwhile, a cross-sectional shape of the first reflective surface 212b is a linear shape intersecting (orthogonal to) the optical axis AX₂₁₂ of the second bar-shaped light guide unit 212. A length L_{212b} of the first reflective surface 212b is shorter than a length L₂₁₂ₐ of the light output surface 212a.

The first reflective surface 212b includes an optical element LC2 configured to cause light which is guided in the second bar-shaped light guide unit 212 and is incident on the first reflective surface 212b to be internally reflected (totally reflected) and outputted from the light output surface 212a. A plurality of optical elements LC2 are provided in a longitudinal direction of the second bar-shaped light guide unit 212. Similarly to the optical element LC1, the optical element LC2 is, for example, a lens cut (for example, a V-shaped groove).

In addition, a cross-sectional shape of the second reflective surface 212c is an arc shape protruding toward an inside of the second bar-shaped light guide unit 212 and connects one end of the light output surface 212a and one end of the first reflective surface 212b (see FIG. 4). Similarly, a cross-sectional shape of the second reflective surface 212d is an arc shape protruding toward the inside of the second bar-shaped light guide unit 212 and connects the other end of the light output surface 212a and the other end of the first reflective surface 212b (see FIG. 4).

As illustrated in FIG. 4, in the embodiment, the three second bar-shaped light guide units 212 are arranged in a state of being adjacent to each other in the vertical direction. At this time, the second bar-shaped light guide units 212 adjacent to each other are connected to each other via connection portions 212e and 212f. Note that the connection portions 212e and 212f are so-called coupling portions having no optical function.

Next, a cross-sectional shape of a second curved portion C2 will be described.

As illustrated in FIG. 12, the second curved portion C2 is a bar-shaped light guide unit (a gradual change portion) having a curved shape that connects the first bar-shaped light guide unit 211 and the second bar-shaped light guide unit 212. The second curved portion C2 is an example of a third bar-shaped light guide unit of the present disclosure. A cross-sectional shape CS_{C2} of the second curved portion C2 is a shape that gradually changes from the fan shape to the ginkgo leaf shape as approaching the second bar-shaped light guide unit 212 from the first bar-shaped light guide unit 211. As described above, the bar-shaped light guide unit having the shape in which the cross-sectional shape thereof gradually changes as the second curved portion C2 is used, thereby preventing a step portion from being formed between the first bar-shaped light guide unit 211 and the second bar-shaped light guide unit 212. Therefore, it is possible to reduce shining or the like of the second curved portion C2 due to light which is guided in the bar-shaped light guide unit 21 and is incident on the step portion.

Next, the first light source 30A and the second light source 30B will be described.

The first light source 30A is, for example, a semiconductor light-emitting element such as an LED that emits amber light. The first light source 30A includes a light-emitting surface (for example, a rectangular light-emitting surface of 1 mm×1 mm). In the embodiment, as illustrated in FIG. 6, the four first light sources 30A are mounted in both upper and lower rows on the substrate 40 (a light source mounting surface) in a state of being arranged in a line in the crosswise direction (the vehicle width direction). Note that the number of the first light sources 30A is not limited to four and may be one or more.

Meanwhile, the second light source 30B is, for example, a semiconductor light-emitting element such as an LED that emits white light. The second light source 30B includes a light-emitting surface (for example, a rectangular light-emitting surface of 1 mm×1 mm). In the embodiment, as illustrated in FIG. 6, the six second light sources 30B are mounted in a middle row on the substrate 40 (the light source mounting surface) in a state of being arranged in a line in the crosswise direction (the vehicle width direction). Note that the number of the second light sources 30B is not limited to six and may be one or more.

The substrate 40 is fixed to the bracket 60 or the like in a state in which the first light source 30A (the light-emitting surface) and the second light source 30B (the light-emitting surface) mounted on this substrate 40 face the light incident surface 22 of the bar-shaped light guide unit 21 (see FIG. 5). In FIG. 6, a dotted line DL₂₂ represents an outer shape of the light incident surface 22 of the bar-shaped light guide unit 21.

In the vehicle lamp 10 having the above-described configuration, a turn signal lamp can be realized by turning on the first light source 30A that emits amber light and turning off the second light source 30B that emits white light.

In the turn signal lamp, an optical path of light emitted by the first light source 30A is as follows. That is, when the first light source 30A is turned on, light emitted from the first light source 30A is incident on the bar-shaped light guide unit 21 from the light incident surface 22 of the bar-shaped light guide unit 21 and is guided toward the distal end FE₂₁ side of the bar-shaped light guide unit 21 through the joining portion 210, the first curved portion C1, the first bar-shaped light guide unit 211, the second curved portion C2, and the second bar-shaped light guide unit 212 in this order while being internally reflected (totally reflected) repeatedly in the bar-shaped light guide unit 21.

A part of the light which is guided in the first bar-shaped light guide unit 211 is internally reflected (diffusely reflected) from the first reflective surface 211b (the optical element LC1) of the first bar-shaped light guide unit 211 and is outputted from the light output surface 211a of the first bar-shaped light guide unit 211.

Similarly, a part of light which is guided in the second curved portion C2 is internally reflected (diffusely reflected) from a first reflective surface (an optical element, not illustrated) of the second curved portion C2 and is outputted from a light output surface of the second curved portion C2.

Similarly, a part of light which is guided in the second bar-shaped light guide unit 212 is internally reflected (diffusely reflected) from the first reflective surface 212b (the optical element LC2) of the second bar-shaped light guide unit 212 and is outputted from the light output surface 212a of the second bar-shaped light guide unit 212.

As described above, the light which is outputted from each light output surface of the bar-shaped light guide unit 21(the first bar-shaped light guide unit 211, the second curved portion C2, or the second bar-shaped light guide unit 212) is transmitted through the inner lens 70 and the outer lens 90 and is radiated within a predetermined angle range of the front of the vehicle. At this time, partial light is directly transmitted through the inner lens 70 and the outer lens 90, and the other partial light is reflected from the left and right wall portions 62 and 63 and the upper and lower wall portions 64 and 65 of the bracket 60, and then is transmitted through the inner lens 70 and the outer lens 90.

As described above, the turn signal lamp is realized by the light (the amber light) which is transmitted through the inner lens 70 and the outer lens 90 and is radiated within the predetermined angle range of the front of the vehicle.

At this time, light which is mainly outputted from the light output surface 211a of the first bar-shaped light guide unit 211 is transmitted through the wide region A₇₀ₐ (see FIGS. 1A and 3) of the inner lens 70, whereby the wide region A₇₀ₐ emits light. At this time, the entire wide region A₇₀ₐ uniformly (substantially uniformly) emits light. Hereinafter, this point will be described in comparison with a comparative example.

The comparative example is an example in which the second bar-shaped light guide unit 212 having a ginkgo leaf-shaped cross section is used instead of the first bar-shaped light guide unit 211 having a fan-shaped cross section. Except for this, the comparative example is similar to the embodiment.

FIG. 8A is a view illustrating an angle range θ1 of light which is outputted from a light output surface 212a of a (one) second bar-shaped light guide unit 212 of a comparative example. FIG. 8B is a view illustrating a range of light which is outputted from the light output surfaces 212a of the (three) second bar-shaped light guide units 212 of the comparative example. FIG. 8C is a view illustrating an angle range θ2 of light which is outputted from the light output surface of a (one) first bar-shaped light guide unit 211 of an embodiment. FIG. 8D is a view illustrating a range of light which is outputted from the light output surfaces of the (three) first bar-shaped light guide units 211 of the embodiment.

As illustrated in FIG. 8A, in the (one) second bar-shaped light guide unit 212 of the comparative example, a relatively dark portion is generated in some regions (for example, see a circular region denoted by reference numeral D1 in FIG. 8A) of the wide region A₇₀ₐ. This is because, in the comparative example, as illustrated in FIG. 8A, the width L₇₀ₐ of the wide region A70a is wider than the angle range θ1 (see FIG. 8A) of the light Ray1 which is outputted from the light output surface 212a of the second bar-shaped light guide unit 212 having the ginkgo leaf-shaped cross section so that the light Ray1 which is outputted from the light output surface 212a of the second bar-shaped light guide unit 212 is not transmitted through the region D1 of the wide region A₇₀ₐ which is present out of the angle range θ1. As a result, in the comparative example, a relatively dark portion is generated in some regions (for example, see a circular region denoted by reference numeral D1 in FIG. 8B) of the wide region A₇₀ₐ, and not the entire wide region A₇₀ₐ can uniformly (or substantially uniformly) emit light.

On the other hand, as illustrated in FIG. 8C, in the (one) first bar-shaped light guide unit 211 of the embodiment, it is possible to reduce generation of a relatively dark portion in some regions (for example, see a circular region denoted by reference numeral D1 in FIG. 8C) of the wide region A₇₀ₐ. This is because, in the embodiment, the angle range θ2 (see FIG. 8C) of the light Ray2 which is outputted from the light output surface 211a of the first bar-shaped light guide unit 211 is larger than the angle range θ1 (see FIG. 8A) of the light Ray 1 which is outputted from the light output surface 212a of the second bar-shaped light guide unit 212 of the comparative example so that the light Ray2 which is outputted from the light output surface 211a of the first bar-shaped light guide unit 211 is to be transmitted through the region D1 of the wide region A₇₀ₐ which is present out of the angle range θ1. As a result, in the embodiment, a relatively dark portion is not generated in any region (for example, see a circular region denoted by reference numeral D1 in FIG. 8D) of the wide region A₇₀ₐ, and the entire wide region A₇₀ₐ uniformly (or substantially uniformly) emits light.

Meanwhile, in the embodiment, light which is mainly outputted from the light output surface 212a of the second bar-shaped light guide unit 212 is transmitted through the narrow region A_{70b} (see FIGS. 1A and 4) of the inner lens 70, whereby the narrow region A_{70b} emits light. At this time, since the width L_{70b} of the narrow region A_{70b} of the inner lens 70 (see FIGS. 1A and 4) corresponds to the angle range θ1 (see FIG. 8A) of the light which is outputted from the light output surface 212a of the second bar-shaped light guide unit 212 having a ginkgo leaf-shaped cross section, the entire narrow region A_{70b} also uniformly (substantially uniformly) emits light.

As described above, according to the embodiment, when the turn signal lamp is realized, the inner lens 70 (the wide region A₇₀ₐ and the narrow region A_{70b}) can uniformly (or substantially uniformly) emit light (a relatively dark portion is not generated in a part of the wide region A₇₀ₐ).

In the vehicle lamp 10 having the above-described configuration, a DRL lamp can be realized by turning off the first light source 30A that emits amber light and turning on, at the first brightness, the second light source 30B that emits white light.

In the DRL lamp, light which is emitted from the second light source 30B follows the same optical path as that of the light which is emitted from the first light source 30A in the turn signal lamp, is outputted from each light output surface of the bar-shaped light guide unit 21 (the first bar-shaped light guide unit 211, the second curved portion C2, or the second bar-shaped light guide unit 212), is transmitted through the inner lens 70 and the outer lens 90, and is radiated within a predetermined angle range of the front of the vehicle. The DRL lamp is realized by the light (the white light with the first brightness) which is transmitted through the inner lens 70 and the outer lens 90 and is radiated within the predetermined angle range of the front of the vehicle. At that time, for the same reason as that of the turn signal lamp, the entire wide region A₇₀ₐ and the entire narrow region A_{70b} of the inner lens 70 uniformly (substantially uniformly) emit light.

As described above, according to the embodiment, also when the DRL lamp is realized, the inner lens 70 (the wide region A₇₀ₐ and the narrow region A_{70b}) can uniformly (or substantially uniformly) emit light (a relatively dark portion is not generated in a part of the wide region A₇₀ₐ).

In the vehicle lamp 10 having the above-described configuration, a position lamp can be realized by turning off the first light source 30A that emits amber light and turning on, at the second brightness darker than the first brightness, the second light source 30B that emits white light.

In the position lamp, light which is emitted from the second light source 30B follows the same optical path as that of the light which is emitted from the first light source 30A in the turn signal lamp, is outputted from each light output surface of the bar-shaped light guide unit 21 (the first bar-shaped light guide unit 211, the second curved portion C2, or the second bar-shaped light guide unit 212), is transmitted through the inner lens 70 and the outer lens 90, and is radiated within a predetermined angle range of the front of the vehicle. The position lamp is realized by the light (the white light with the second brightness) which is transmitted through the inner lens 70 and the outer lens 90 and is radiated within the predetermined angle range of the front of the vehicle. At that time, for the same reason as that of the turn signal lamp, the entire wide region A₇₀ₐ and the entire narrow region A_{70b} of the inner lens 70 uniformly (substantially uniformly) emit light.

As described above, according to the embodiment, also when the position lamp is realized, the inner lens 70 (the wide region A₇₀ₐ and the narrow region A_{70b}) can uniformly (or substantially uniformly) emit light (a relatively dark portion is not generated in a part of the wide region A₇₀ₐ).

As described above, according to the embodiment, the inner lens 70 (the wide region A₇₀ₐ and the narrow region A_{70b}) can uniformly (or substantially uniformly) emit light (a relatively dark portion is not generated in a part of the wide region A₇₀ₐ).

This is because, firstly, the cross-sectional shape CS₂₁₁ of the first bar-shaped light guide unit 211 (see FIGS. 3 and 12) and the cross-sectional shape CS₂₁₂ of the second bar-shaped light guide unit 212 (see FIGS. 4 and 12) are set to different shapes from each other such that the angle range θ2 (see FIG. 8C) of the light which is guided in the first bar-shaped light guide unit 211 and is outputted from the light output surface 211a of the first bar-shaped light guide unit 211 is larger than the angle range θ1 (see FIG. 8A) of the light which is guided in the second bar-shaped light guide unit 212 and is outputted from the light output surface 212a of the second bar-shaped light guide unit 212, and secondly, the first bar-shaped light guide unit 211 is arranged behind the wide region A₇₀ₐ (see FIG. 3) such that the light which is outputted from the light output surface 211a of the first bar-shaped light guide unit 211 is transmitted through this wide region A₇₀ₐ, and the second bar-shaped light guide unit 212 is arranged behind the narrow region A_{70b} (see FIG. 4) such that the light which is outputted from the light output surface 212a of the second bar-shaped light guide unit 212 is transmitted through this narrow region A70b.

Next, modified examples will be described.

In the above-described embodiment, an example has been described, in which the light guide body including the three bar-shaped light guide units 21A to 21C is used as the light guide body 20, but the present invention is not limited thereto. For example, a light guide body including one or a plurality of bar-shaped light guide units may be used as the light guide body 20.

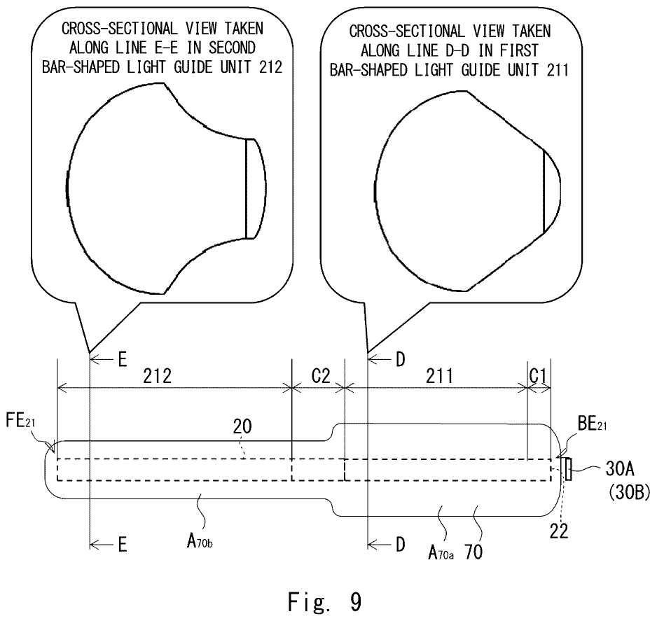

In addition, in the above-described embodiment, an example has been described, in which the L-shape is employed as the shape of the inner lens 70, and the bar-shaped light guide unit having a three-dimensionally curved shape corresponding to the shape (the L-shape) of the inner lens 70 is employed as the bar-shaped light guide unit 21, but the present invention is not limited thereto. For example, as illustrated in FIG. 9, a linear shape may be employed as the shape of the inner lens 70, and a bar-shaped light guide unit having a linear shape corresponding to the shape (the linear shape) of the inner lens 70 may be used as the bar-shaped light guide unit 21. FIG. 9 illustrates a first modified example of the bar-shaped light guide unit 21 and the inner lens 70.

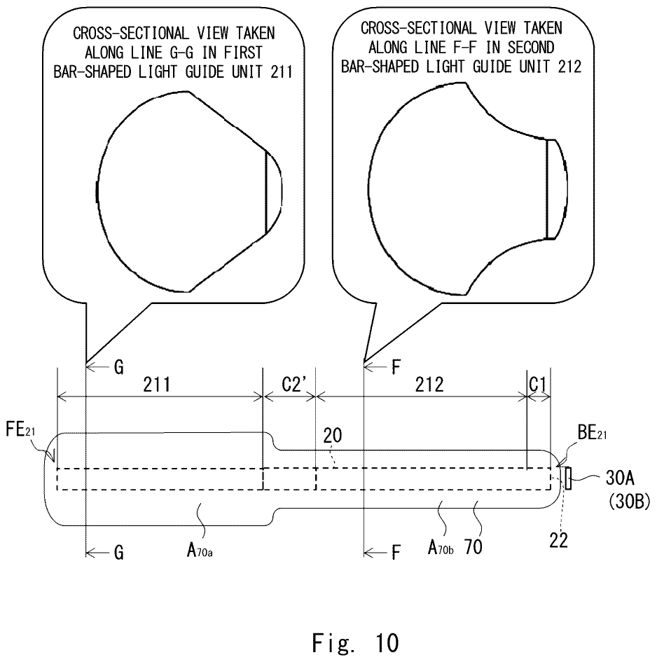

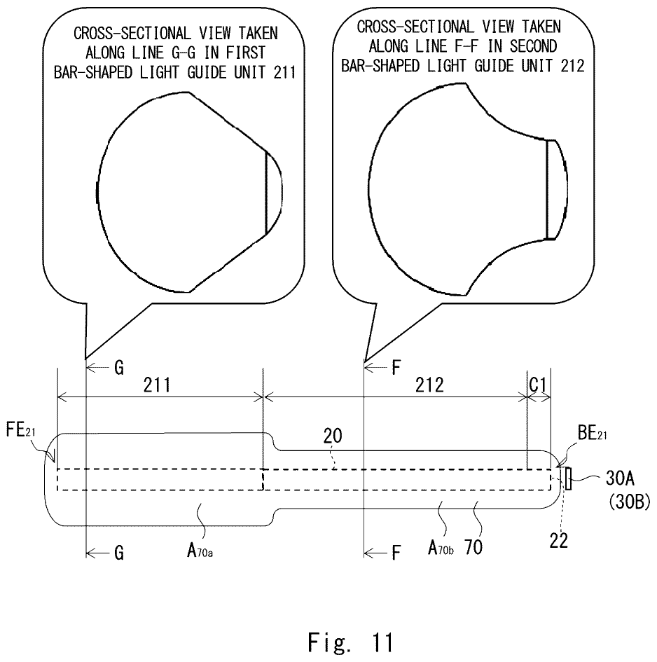

In addition, in the above-described embodiment, an example has been described, in which the first bar-shaped light guide unit 211 is arranged on the light source side (the side of the first light source 30A and the second light source 30B) and the second bar-shaped light guide unit 212 is arranged on the opposite side of the light source (see FIGS. 2 and 9), but the present invention is not limited thereto. For example, as illustrated in FIG. 10, the second bar-shaped light guide unit 212 may be arranged on the light source side (the side of the first light source 30A and the second light source 30B), and the first bar-shaped light guide unit 211 may be arranged on the opposite side of the light source. FIG. 10 illustrates a second modified example of the bar-shaped light guide unit 21 and the inner lens 70. Note that a gradual change portion C2′ in FIG. 10 is a part of the bar-shaped light guide unit 21 having a cross-sectional shape that gradually changes from a ginkgo leaf shape to a fan shape as approaching the first bar-shaped light guide unit 211 from the second bar-shaped light guide unit 212. Note that, as illustrated in FIG. 11, the gradual change portion C2′ may be omitted. FIG. 11 illustrates a third modified example of the bar-shaped light guide unit 21 and the inner lens 70.

Each numerical value illustrated in each of the above embodiments is an example, and it is a matter of course that an appropriate numerical value different from this can be used.

Each of the above embodiments is merely an example in all respects. The present disclosure is not to be construed as being limited by the description of each of the above embodiments. The present disclosure can be implemented in various other forms without departing from the spirit or main characteristics thereof.

This application claims priority based on Japanese Patent Application No. 2023-078376 filed on May 11, 2023, the entire disclosure of which is incorporated herein.

### REFERENCE SIGNS LIST

10 VEHICLE LAMP
20 LIGHT GUIDE BODY
21, 21A, 21B, 21C BAR-SHAPED LIGHT GUIDE UNIT
22 LIGHT INCIDENT SURFACE
30A FIRST LIGHT SOURCE
30B SECOND LIGHT SOURCE
40 SUBSTRATE
50 HEAT SINK
60 BRACKET
61 BRACKET MAIN BODY
62, 63 LEFT AND RIGHT WALL PORTIONS
64, 65 UPPER AND LOWER WALL PORTIONS
70 INNER LENS
80 EXTENSION
90 OUTER LENS
100 HOUSING
210 JOINING PORTION
211 FIRST BAR-SHAPED LIGHT GUIDE UNIT
211a LIGHT OUTPUT SURFACE
211b FIRST REFLECTIVE SURFACE
211c, 211d SECOND REFLECTIVE SURFACE
211e, 211f CONNECTION PORTION
212 SECOND BAR-SHAPED LIGHT GUIDE UNIT
212a LIGHT OUTPUT SURFACE
212b FIRST REFLECTIVE SURFACE
212c, 212d SECOND REFLECTIVE SURFACE
212e, 212f CONNECTION PORTION
A₇₀ₐ WIDE REGION
A_{70b} NARROW REGION
AX₂₁₁, AX₂₁₂ OPTICAL AXIS
BE₂₁ PROXIMAL END
C1 FIRST CURVED PORTION
C2 SECOND CURVED PORTION
C2′ GRADUAL CHANGE PORTION
CS₂₁₁, CS₂₁₂, CS_{C2} CROSS-SECTIONAL SHAPE
FE₂₁ DISTAL END
LC1, LC2 OPTICAL ELEMENT
Ray1, Ray2 LIGHT

1. A vehicle lamp comprising:
a light source;
an inner lens configured to include a wide region and a narrow region; and
a light guide body configured to include at least one bar-shaped light guide unit that guides light emitted by the light source, wherein
the bar-shaped light guide unit includes a first bar-shaped light guide unit extending in a first direction and a second bar-shaped light guide unit extending in a second direction,
a cross-sectional shape of the first bar-shaped light guide unit and a cross-sectional shape of the second bar-shaped light guide unit are set to different shapes from each other such that an angle range of light which is guided in the first bar-shaped light guide unit and is outputted from a light output surface of the first bar-shaped light guide unit is larger than an angle range of light which is guided in the second bar-shaped light guide unit and is outputted from a light output surface of the second bar-shaped light guide unit,
the first bar-shaped light guide unit is arranged behind the wide region such that light outputted from the light output surface of the first bar-shaped light guide unit is transmitted through the corresponding wide region, and
the second bar-shaped light guide unit is arranged behind the narrow region such that light outputted from the light output surface of the second bar-shaped light guide unit is transmitted through the corresponding narrow region.

2. The vehicle lamp according to claim 1, wherein
the cross-sectional shape of the first bar-shaped light guide unit is a fan shape, and
the cross-sectional shape of the second bar-shaped light guide unit is a ginkgo leaf shape.

3. The vehicle lamp according to claim 2, wherein
the second direction is a direction intersecting the first direction,
the light guide body includes a third bar-shaped light guide unit having a curved shape which connects the first bar-shaped light guide unit and the second bar-shaped light guide unit, and
a cross-sectional shape of the third bar-shaped light guide unit is a shape which gradually changes from the fan shape to the ginkgo leaf shape as approaching the second bar-shaped light guide unit from the first bar-shaped light guide unit.

4. The vehicle lamp according to claim 1, wherein a diameter of the first bar-shaped light guide unit is substantially equal to a diameter of the second bar-shaped light guide unit.

5. The vehicle lamp according to claim 4, wherein curvature of the light output surface of the first bar-shaped light guide unit and curvature of the light output surface of the second bar-shaped light guide unit are different from each other.

6. The vehicle lamp according to claim 1, wherein the light guide body includes a plurality of the bar-shaped light guide units arranged parallel to each other.

7. The vehicle lamp according to claim 6, wherein
the plurality of bar-shaped light guide units join each other on respective proximal end sides thereof to form one joining portion having no boundary therebetween, and
the joining portion has, at a distal end thereof, a light incident surface on which light emitted from the light source is incident.

8. A light guide body comprising at least one bar-shaped light guide unit that guides light emitted by a light source, wherein
the bar-shaped light guide unit includes a first bar-shaped light guide unit extending in a first direction and a second bar-shaped light guide unit extending in a second direction,
a cross-sectional shape of the first bar-shaped light guide unit and a cross-sectional shape of the second bar-shaped light guide unit are set to different shapes from each other such that an angle range of light which is guided in the first bar-shaped light guide unit and is outputted from a light output surface of the first bar-shaped light guide unit is larger than an angle range of light which is guided in the second bar-shaped light guide unit and is outputted from a light output surface of the second bar-shaped light guide unit, and
the cross-sectional shape of the first bar-shaped light guide unit is a fan shape, and
the cross-sectional shape of the second bar-shaped light guide unit is a ginkgo leaf shape.
